(19) United States
(12) Patent Application Publication
(10) Pub. No.: US 2023/0113147 A1
(43) Pub. Date: Apr. 13, 2023

(54) FLOATING OFFSHORE WIND TURBINE SUBSTRUCTURE

(71) Applicant: Keystone Engineering Inc., Mandeville, LA (US)

(72) Inventors: Sara GHAZIZADEH, Denver, CO (US); Rudolph A. HALL, Mandeville, LA (US); Frank J. FALGOUT, JR., Terrytown, LA (US); Rick Riccardo DAMIANI, Arvada, CO (US)

(73) Assignee: Keystone Engineering Inc., Mandeville, LA (US)

(21) Appl. No.: 18/046,154

(22) Filed: Oct. 12, 2022

Related U.S. Application Data
(60) Provisional application No. 63/254,961, filed on Oct. 12, 2021.

(51) Int. Cl. B63B 35/44; F03D 13/25; B63B 39/00

(52) U.S. Cl. CPC B63B 35/44; B63B 39/00; F03D 13/25; B63B 2035/446

(57) ABSTRACT

A floating substructure made of a steel structure with ballast tanks provides buoyancy and stability to support a wind turbine generator in deep waters. Mooring lines directly attach to the substructure to provide stability. These mooring lines can also be directly anchored to the bed of a body of water, such as a seabed, to control movements. Different types of anchors can be used depending on the soil characteristic of the bed of the body of water.

### CROSS-REFERENCE TO RELATED APPLICATIONS

This application claims the benefit of priority to U.S. Provisional Pat. Application No. 63/254,961, filed on Oct. 12, 2021, which is hereby incorporated herein by reference in its entirety.

### TECHNICAL FIELD

This disclosure relates to offshore wind turbine substructures that are anchored to a bottom of a body of water such as a seabed, lakebed, riverbed, estuary bed, and the like.

### BACKGROUND

A wind turbine is supported by a structure that is directly connected to a bottom of a body of water such as a seabed, lakebed, riverbed, estuary bed, and the like. This structure also directly connects to the wind turbine to balance the wind turbine generator weight and support it during tides and storms.

### SUMMARY

This disclosure provides an offshore substructure comprising a central hull, a plurality of legs, a plurality of braces, ballast, and a plurality of moors. The plurality of legs is positioned around the central hull. Each of the plurality of braces is directly connected to the central hull and to one of the plurality of legs. The ballast is positioned in at least one of the central hull and the plurality of legs. Each one of the plurality of legs and the central hull is attached to a respective one of the plurality of moors at a first end, and each one of the plurality of moors is attached to an anchor at a second end.

This disclosure also provides an offshore substructure comprising a central hull, four legs, a plurality of braces, a first pair of moors, and a second pair of moors. The four legs are positioned around the central hull. Each of the plurality of braces is directly connected to one of the four legs and to the central hull. The first pair of moors includes a first moor and a second moor, each of the first moor and the second moor is connected to a respective leg of a first pair of the four legs. The first moor of the first pair crosses from a first side of the second moor of the first pair to a second side of the second moor of the first pair when viewed from above the central hull. The second pair of moors includes a first moor and a second moor, each of the first moor and the second moor connected to a respective leg of a second pair of the four legs. The first moor of the second pair crossing from a first side of the second moor of the second pair to a second side of the second moor of the second moor when viewed from above the central hull.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1A shows a perspective view of a substructure in accordance with an exemplary embodiment of the present disclosure.

FIG. 1B shows a perspective view of another substructure in accordance with another exemplary embodiment of the present disclosure.

FIG. 2 shows an elevation view of the substructure of FIG. 1A anchored to a seabed by a plurality of mooring lines.

FIG. 3 shows a sectional view of a racetrack brace of the substructure of FIG. 1A.

FIG. 4 shows a plan view of the substructure of FIG. 1A.

FIG. 5 shows a first elevation view of the substructure of FIG. 1A anchored to a seabed.

FIG. 6 shows a second elevation view of the substructure of FIG. 1A anchored to the seabed.

FIG. 7 shows a stylized sectional view of the substructure of FIG. 1A, showing internal features of the substructure.

FIG. 8 shows another stylized sectional view of a substructure similar to that of FIG. 1A showing internal features of the substructure in accordance with another exemplary embodiment of the present disclosure.

FIG. 9 shows features that can be attached to the substructure of FIG. 1A or FIG. 1B.

FIG. 10 shows a perspective view of a substructure in accordance with another embodiment of the present disclosure with braces removed.

FIG. 11 shows an elevation view of the substructure of FIG. 10.

FIG. 12 shows a top plan view of the substructure of FIG. 10.

FIG. 13 shows a top plan view similar to FIG. 12 of a further substructure embodiment of the present disclosure.

FIG. 14 shows a top plan view of the substructure of FIG. 11 with braces shown.

FIG. 15 shows an elevation view of the substructure of FIG. 14.

FIG. 16 shows a top plan view of a substructure in accordance with yet another a still further exemplary embodiment of the present disclosure.

### DETAILED DESCRIPTION

The majority of current offshore wind turbine substructures have fixed foundation designs that are piled in the seabed, e.g., monopiles or jackets, or rest on a seabed, e.g., a gravity-based structure (GBS) in relatively shallow water. However, to harness more wind further offshore and in deeper waters, a floating substructure design provides advantages over fixed foundation designs.

A conventional floating tension leg platform (TLP) includes a relatively small seabed footprint and limits motion of a turbine rotor nacelle assembly (RNA) of a wind turbine as compared to other floater archetypes. The typical TLP requires additional measures during transportation to ensure stability while towed. These measures may include additional ballasting tanks and buoyancy units. A conventional spar-buoy platform includes a low center of gravity but is difficult to tow because the draft of such platforms is relatively deep. In contrast to these designs, the present embodiments may be described as a hybrid between a spar-buoy configuration and a TLP configuration, which is described herein as a KeyFLOAT. In a KeyFLOAT design, ballast is added for optimal towing depth and stability. Once the KeyFLOAT design is in place, ballast can be removed or adjusted and preload of mooring lines or tendons can be adjusted to the proper preload, as discussed further hereinbelow.

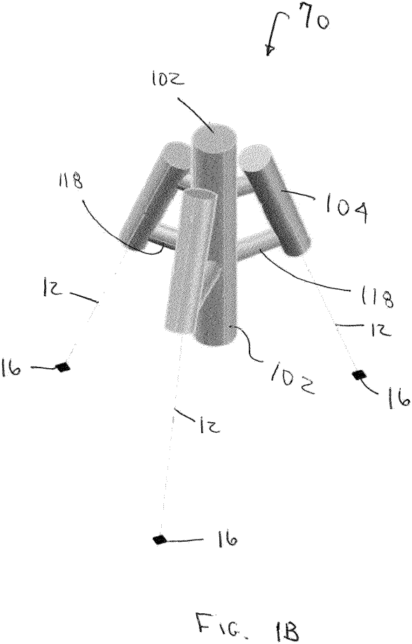

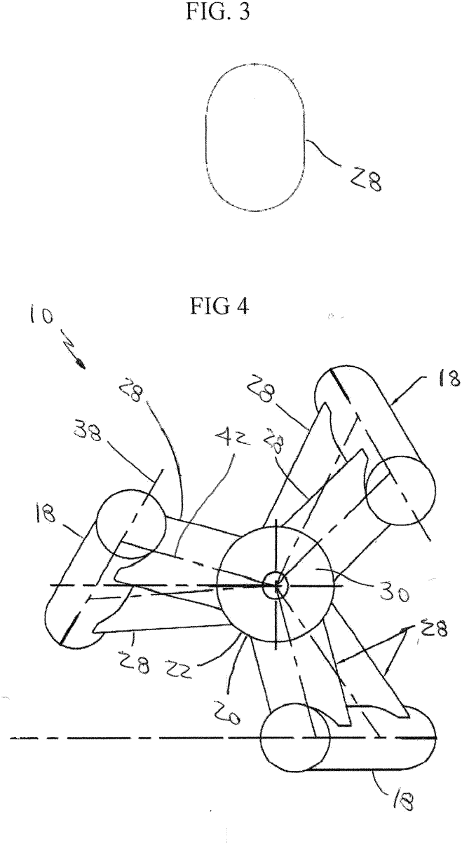

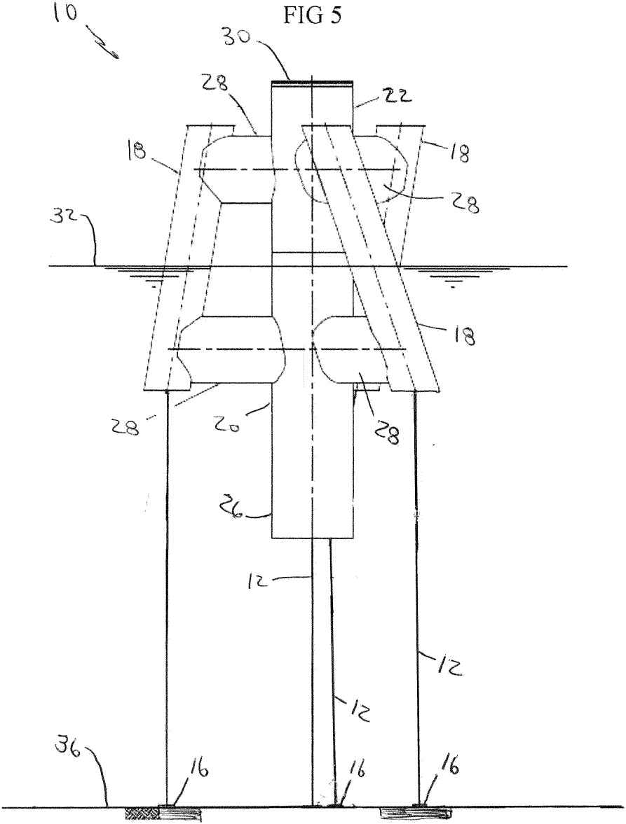

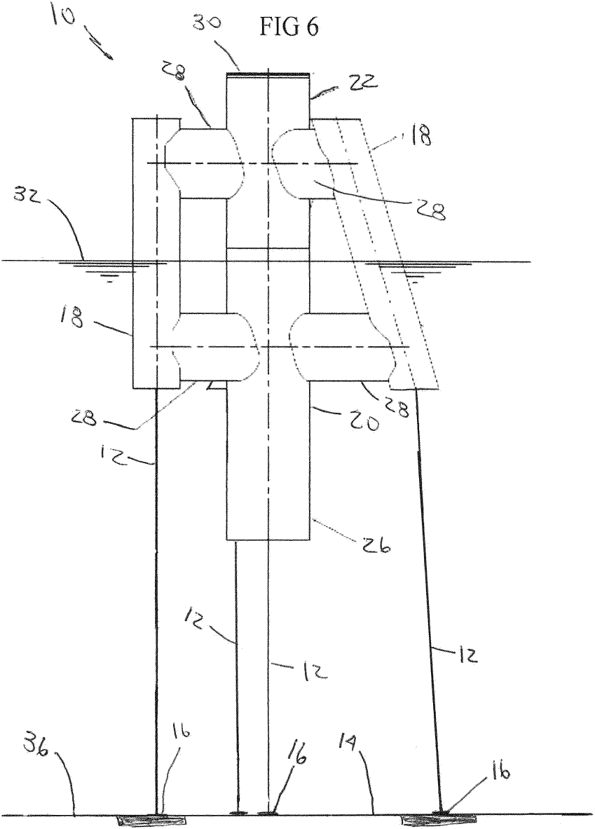

The present disclosure describes a floating substructure made entirely or partially of a steel and/or concrete structure with ballast tanks to provide buoyancy and stability, such as substructure 10 shown in FIGS. 1A-7. Mooring lines 12 directly attach to substructure 10 to provide stability. Mooring lines 12 get directly anchored to a bed 14 of a body of water to control movements of substructure 10 and a supported device, such as a wind turbine. In an embodiment, mooring lines 12 can be segmented to connect to each other such that a mooring line connected to a wind turbine connects to one or more mooring lines 12, one or more of which is directly anchored to bed 14 of the body of water. Different types of anchors 16 can be used depending on the soil characteristic of the seabed.

For the sake of simplicity, the bottom of various bodies of water described herein are described as a seabed or seabeds. It should be apparent that the system described herein is suitable for use on a lakebed, a riverbed, an estuary bed, and other bodies of water where floating support of a wind turbine can be advantageous.

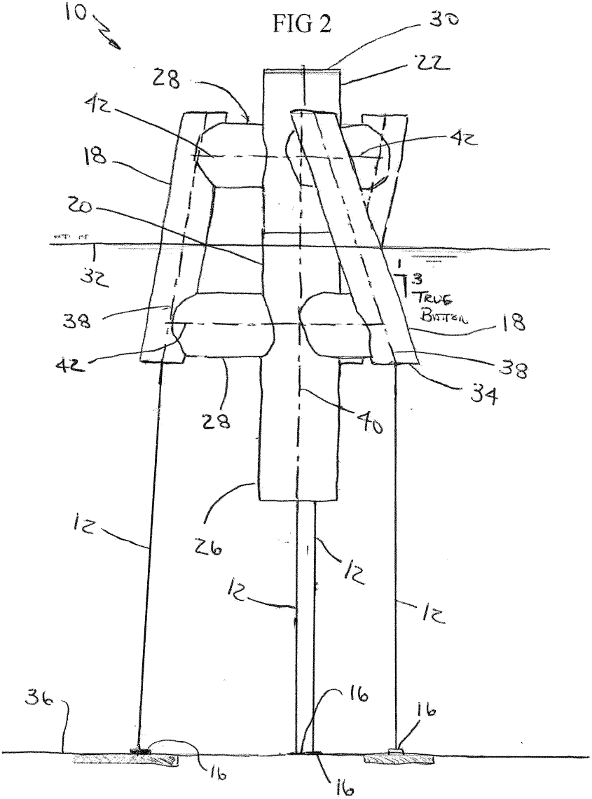

The design of floating substructure 10 includes three battered legs 18 that attach to a central hull 20 with an upper portion of central hull 20 as a transition piece 22 connecting to a wind turbine generator tower 24 and a bottom portion used for buoyancy, ballasting, and stability of the integrated structure. In an embodiment, a batter angle, which can be inward toward hull 20 or outward away from hull 20, is chosen so that an apex, which is a location defined by an intersection of virtual centerlines of each of the battered legs, is in proximity of a nacelle 44 of the turbine to minimize its motion. Such configuration is shown in FIG. 1B, discussed in more detail herein. Central hull 20 houses internal platforms in transition piece section 22 and ballast tanks. The internal platforms and ballast tanks may be separated by bulkheads and doors that create watertight compartments. Battered legs 18 can be attached to central hull 20 with horizontally extending braces 28 that have a shape that can be described as an oval, racetrack, obround, or stadium, as shown in FIG. 3 and as disclosed in U.S. Pat. No. 9,725,868, the entirety of which is incorporated by reference in its entirety.

Primary components of floating substructure 10, which may be described as a floating substructure system 10, include central hull 20, battered legs 18, braces 28, mooring lines or pre-loaded tendons 12, and anchors 16. When mooring lines 12 are taut, i.e., are under tension with a pre-load, mooring lines 12 can be described as pre-loaded tendons 12. A first upper end of each mooring line 12 can be attached at a location that is at a centerline 38 of a respective leg 18 and/or a centerline 40 of hull 20. A second lower end of each mooring line 12 is attached to a respective anchor 16.

Central hull 20 includes transition piece 22 and ballasting. At the top of transition piece 22 is an interface 30 that provides a location to interface with upper attachments, such as a support for a windmill, wind turbine 24, platforms, a tower, and/or other features. Transition piece 22 can house internal platforms and/or mechanical and/or electrical support elements for a supported wind turbine generator based on predetermined requirements. Ballast tanks or compartments can be positioned in central hull 20 to provide buoyancy and stability for substructure 10. The ballast tanks or compartments can be arrayed symmetrically or asymmetrically around and through central hull 20. The ballast tanks or compartments can be adjusted at the time of installation of floating substructure 10. Alternatively, floating substructure 10 can include sensors, for example, accelerometers, level gauges, balance gauges, and the like and signals from these devices can be used to provide dynamic balancing of floating substructure 10 during high wind or wave conditions or wind turbine generator malfunction.

Legs 18 are battered at a 1 on 3 batter and can be twisted around the hull. The orientation of battered legs 18 helps with providing additional stability to central hull 20. The section or portion of legs 18 below waterline 32 can include ballast tanks for added buoyancy and stability.

Horizontal braces 28, also described as racetrack members, connect battered legs 18 to central hull 20 and transfer the wind turbine and Metocean loads from central hull 20 and transition piece 22 to battered legs 18. As with central hull 20 and battered legs 18, braces 28 below waterline 32 include ballast tanks that can be used for fine tuning of buoyancy and stability during operation. The attachment of braces 28 to legs 18 in an exemplary embodiment may be such that a centerline 42 of an attaching brace 28 intersects a centerline 38 of leg 18 and centerline 40 of hull 20.

Mooring lines 12 are attached directly to central hull 20 and to the battered legs. Mooring lines 12 provide stability and provide seakeeping for floating substructure 10 and prevent substructure 10 from drifting excessively. Winches 34 may be located or positioned within the inward battered legs and central hull 20 to adjust or maintain tension in mooring lines 12. Winches 34 may be located at any location in the inward battered legs and/or central hull 20. For example, in an exemplary embodiment winches 34 can be positioned or located in a lower or bottom end of the inward battered legs and central hull 20, which simplifies routing of mooring lines 12 from an interior of the inward battered legs and/or central hull 20.

In an embodiment, anchors 16 are sunk into the surface of the ground below the water, e.g., the seabed. The seabed may be defined by mud, sand, rock, or the like. Accordingly, the seabed may include a mudline, sand line, rock line or the like 36 that defines an outer surface of the bed. Anchors 16 may be attached to suction piles driven into the seabed, or may be attached to underwater rocks or weights having sufficient size and weight to withstand any loads transferred by mooring lines or tendons 12 and by floating substructure 10 and wind turbine 24 in all predetermined wind and wave conditions. Anchors 16 and mooring by mooring lines 12 provide stability to floating substructure 10 and supported wind turbine by limiting and/or preventing movement of floating substructure 10. Any suitable anchor can be used based on the characteristics of the seabed and expected loads.

Floating substructure 10 system can include secondary components such as boat fenders, ladders, and an externally located landing platform. The landing platform can serve as an access platform to central hull 20, or a separate access platform may be reached by one or more ladders and/or intermediate platforms that can be positioned adjacent to an access port or door into the inward battered legs, the racetrack braces, and the transition piece.

Secondary components can also include a davit crane for moving or raising and lowering equipment from a boat at the water adjacent and/or under floating substructure 10, j-tubes for cables, a cathodic/anodic protection system 74/76, navigation aids, safety signs, and gates.

Floating substructure system 10 can also include a variety of optional elements such as an automatic ballast adjustment system, a winch system, and suction anchors 16, some of which have been mentioned above. The automatic ballast system is configured to receive signals from a plurality of sensors that can measure the amplitude and period of movement of floating substructure system 10 under various wave and wind conditions and wind turbine generator loading. The amplitude and period of movement can be used to adjust ballast in one or more of legs 18, braces 28, and central hull 20 to ensure that the frequency of floating substructure system 10 is within the allowable range provided by the turbine OEM.

While a winch system was described above, such system can be optional depending on site characterizations. Depending on the conditions of a specific site, tension in mooring lines 12 may need to be adjusted to a specified tension value and the winch system can be used to adjust the tension by activating individual winches 34. In lieu of a mechanical winch system, the prescribed tension for mooring lines 12 can be achieved by adjustable ballast tanks or compartments to increase the stability of the floating substructure system 10 by adjusting the tension and length of mooring lines 12 to assist in dampening the amplitude and frequency of movement of floating substructure system 10 under various wave and wind conditions and wind turbine generator loading. As described herein, the winch system can include a plurality of winches 34 positioned in one or more of legs 18, braces 28, and/or central hull 20. While winches 34 can be located at any location within legs 18, braces 28, and/or central hull 20, in an exemplary embodiment winches 34 can be located at a lower or bottom end of legs 18, braces 28, and/or central hull 20, above an internal waterline of legs 18, braces 28, and/or central hull 20. In another exemplary embodiment, winches 34 can be located in any of the aforementioned locations at a level above external waterline 32 of the water body.

The winch systems can also be integrated with the automatic ballast control and work in conjunction with motion sensors and accelerometers. This integration enables a seamless constant dynamic adjustment system for floating substructure 10 subjected to various environmental or wind turbine generator loading conditions. This system, which includes a processor, may retain the motion data in non-transitory computer readable media such that further data manipulation for research and development studies may be performed.

For attachment of mooring lines 12 to seabed 14, rock anchors or suction anchors are anticipated as being a preferred attachment configuration. During installation, by applying negative pressure to an interior of the suction bucket, water pressure embeds the suction buckets (anchors) into the seabed and afterwards friction holds anchors 16 from uplift to stabilize floating substructure system 10.

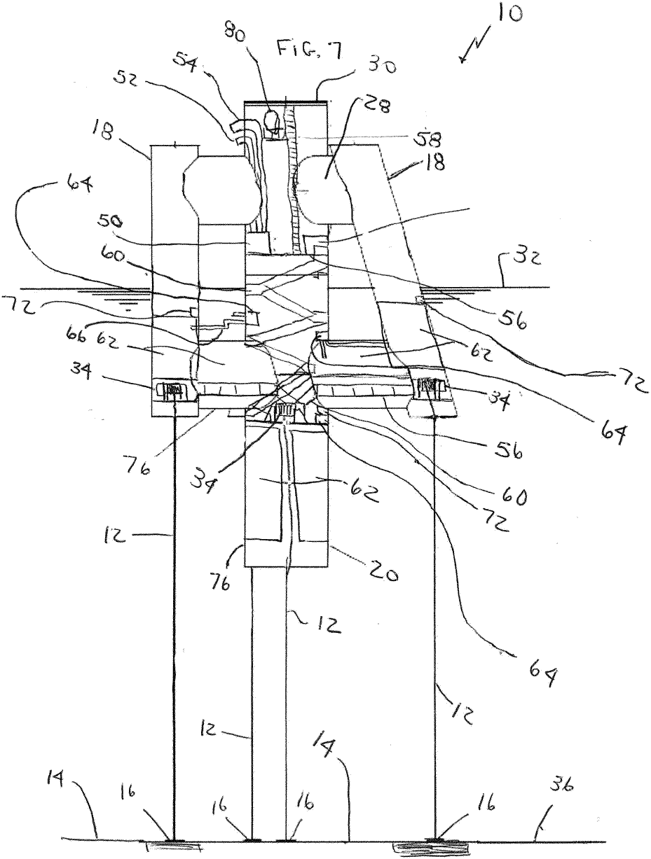

While internal features of any substructure, including substructure 10, can vary significantly depending on application, FIG. 7 shows some of the features that may exist in the interior of substructure 10. It should be noted that most features shown in FIG. 7 are above an internal waterline of substructure 10, though such features may be below external waterline 32. Seals and airlocks may exist to maintain air cavities below external waterline 32.

Access to substructure 10 can be by a door or hatch 80. As described elsewhere herein, each leg 18 and central hull 20 can include a winch 34 to place tension on moors/mooring lines/tendons 12. Winches 34, and other features of substructure 10, can either be powered by power from wind turbine 24 or by an auxiliary generator 50. Generator 50 can either be positioned external to substructure 10 or internal to substructure 10. If generator 50 is positioned internal to substructure 10, an air intake 52 and an exhaust 54 can be connected to generator 50 to enable air passage from an exterior of substructure 10 to generator 50 and passage of exhaust from generator 50 to an exterior of substructure 10. Internal to substructure 10 can be work platforms 56 in one or more braces 28 and hull 20, ladders 58 internal or external to hull 20, and stairs 62 internal to hull 20 and/or braces 28.

Ballast tanks or cavities 62 can be located in a lower portion of each leg 18, hull 20, and braces 28. Ballast pumps 64 can be connected to each ballast tank or cavity to pump fluid into and out from ballast tanks or cavities 62 by way of pipes and hoses 66.

Control of various systems can be by way of a central control system 68. Control system 68 can include a processor, a non-transitory computer readable medium, communication interfaces to communicate by radio for long distances external to substructure 10 or by Wi-Fi or Bluetooth to systems on substructure 10 or nearby to substructure 10. Control system 68 can also communicate with a plurality of sensors 72, which may sense internal and external temperature, internal air pressure, ambient air pressure, tilt, humidity, and other atmospheric and equipment conditions of substructure 10.

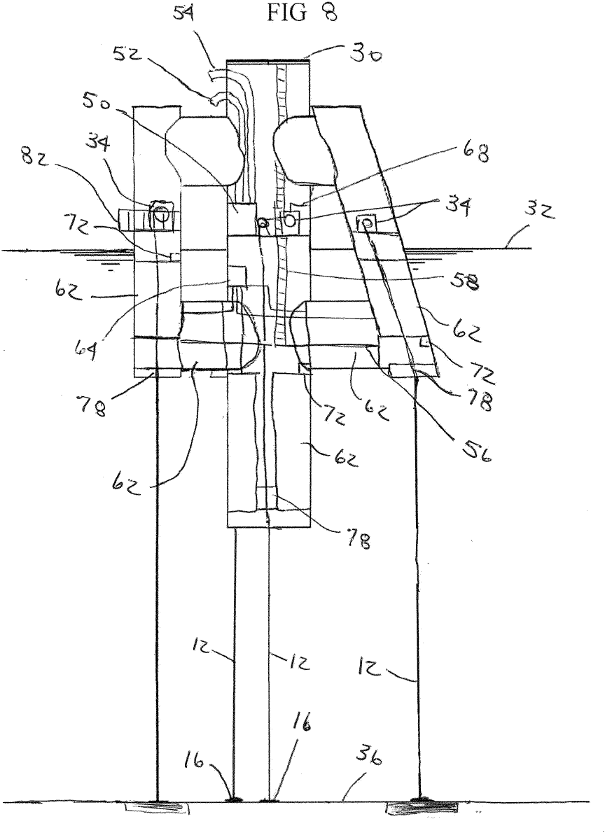

FIG. 8 shows another internal configuration of substructure 10, which each reference numeral similar to the reference numerals in FIG. 7 similarly labeled. FIG. 8 also shows winch line seals that block water intrusion into legs 18 and hull 20. An external landing platform 82 may be position on one or more of legs 18 and/or hull 20. Platform 82 can be positioned above waterline 82 under a deepest draft condition of substructure 10 so that platform 82 remains uncovered by water when water conditions are not rough enough for waves to crash over platform 82.

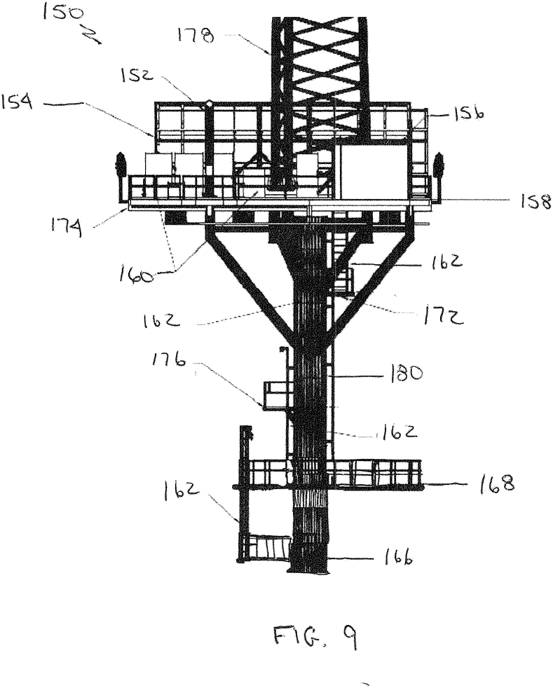

FIG. 9 shows a tower 150 that can be supported on substructure 10. Tower 150 can include a crane 152, solar panels 154, and an instrumentation shelter 156, all of which can be supported on a main deck 174. Solar panels 154 can be directly connected to battery boxes 160, which can also be supported on main deck 174. Other platforms include an upper access platform 158, an intermediate platform 172, a lower access platform 168, an overboard landing platform 166, and an intermediate landing platform 176. A plurality of ladders 162 can connect the various platforms to each other. A metal tower 178 can be supported by main deck 174. A main support shaft 180 connects to interface 30 and supports all the above-described features of tower 150.

FIG. 8 shows another stylized internal sectional view of a substructure similar to that of FIG. 1A in accordance with another exemplary embodiment of the present disclosure. The features of the substructure of FIG. 8 are similar to those of FIG. 7, though with a slightly different layout of components. For example, FIG. 8 includes a landing platform near to the water line.

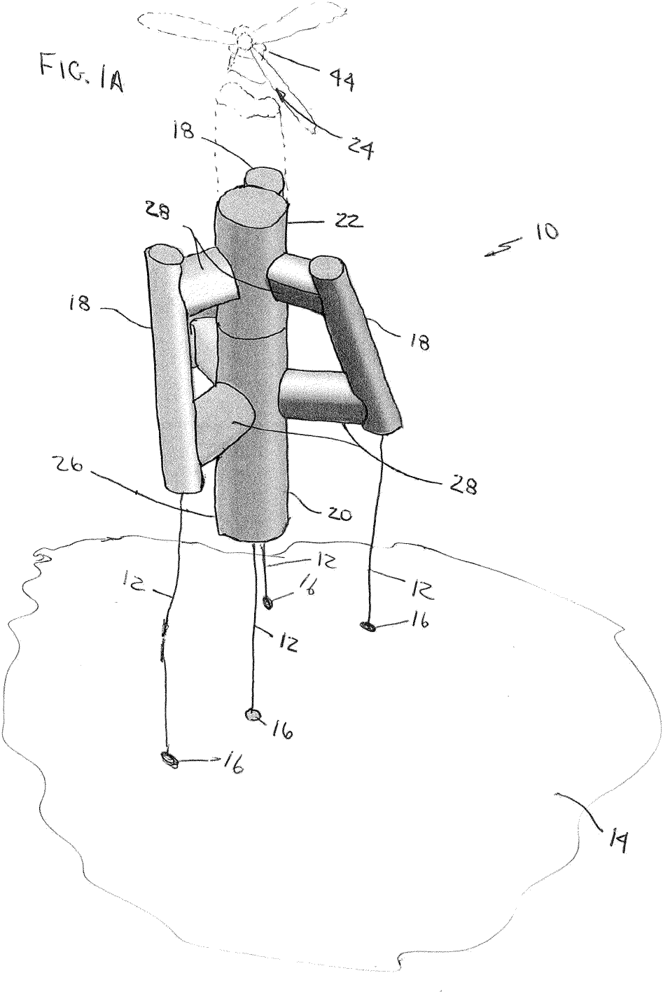

FIG. 9 shows features that can be attached to the substructure of FIG. 1A. The features of FIG. 9 may be partially attached to the substructure of FIG. 1A, or they may be attached to the interface of the substructure of FIG. 1A, which is shown in, for example, FIGS. 2, 6, and 7.

FIG. 1B shows a substructure 70 in accordance with another exemplary embodiment of the present disclosure. Substructure 70 includes three inwardly battered legs 104 directly connected to a plurality of braces 118, and braces 118 are directly connected to central hull 20. Each leg 104 is connected to a mooring line or tendon 12, each of which is connected to a respective anchor 16.

Dimensions of substructures are chosen in view of the dimensions and weight of a supported device. As an example, for a 3-legged KeyFLOAT substructure 10, a preferred batter angle is around 5 deg for a typical 15-MW class turbine. It should be understood that batter angles can be single angles in a circumferential direction, or can be compound angle including in a circumferential direction and either inwardly toward central hull 20 or outwardly away from central hull 20. Central hull 20, which can also be described as a stem, has a diameter of approximately 10 meters, a draft of approximately 40 meters, and legs approximately 6 meters in diameter at 12-15 meters from centerline 40. Approximately when applied to the dimensions in this application can be plus or minus 20 percent of the respective dimension. However, plus or minus 10 percent of each dimension is preferred, and plus or minus 5 percent is most preferred.

The wall thicknesses for hull or stem 20, legs 18, and braces 28 are in a range of about 0.5 to 1.0 inches, or about 12 millimeters to about 26 millimeters. In addition, each of hull or stem 20, legs 18, and braces 28 can include longitudinal and ring stiffeners as conventional practice in offshore engineering. The draft can be reduced by increasing the diameters of central stem 20 and legs 18, which increases the amount of water displacement, increasing buoyancy of substructure 10.

While a preferred angle for the batter may be 5 degrees, the batter angle may be increased for ease of manufacturing to a range between 15 to 20 degrees, and stability improved by optimizing the tendon preload together with the size of the individual members.

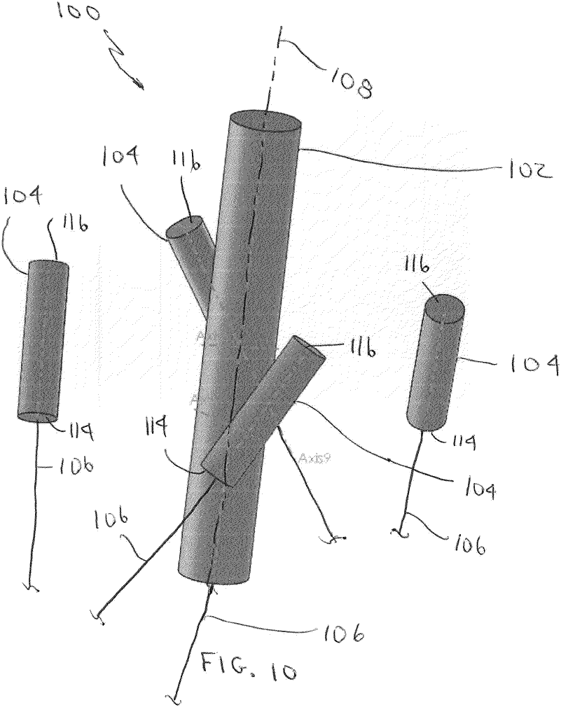

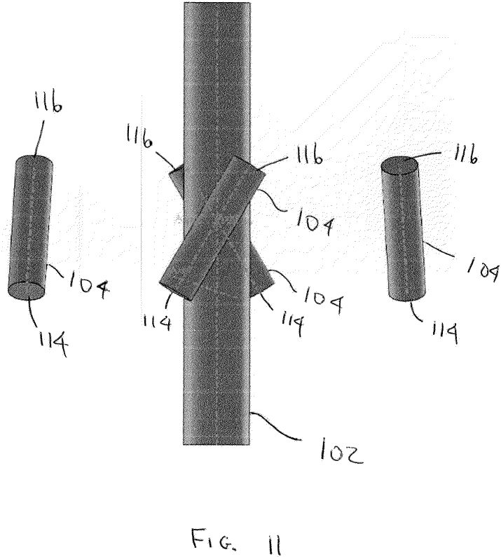

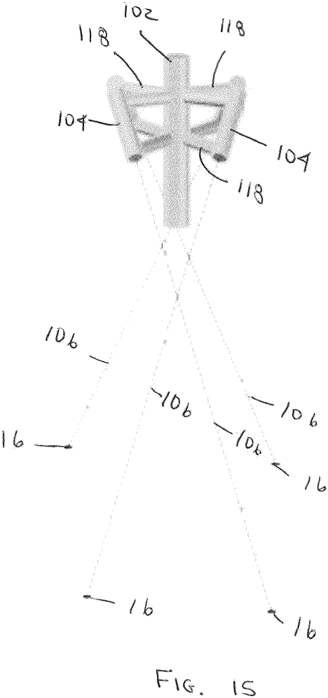

FIGS. 10-16 show substructures in accordance with further embodiments of the present disclosure. FIGS. 10-13 show substructure 100 with braces removed for clarity. While braces are removed in these figures, substructure 100 includes braces similar to braces 28 shown in, for example, FIGS. 1A-6.

Substructure 100, which may be described as a 4-legged KeyFLOAT, is composed of central hull or stem 102 and 4 legs 104. Mooring lines 12 are replaced with relatively rigid tendons or rods 106 (or a plurality of bundled steel wires) that are preloaded to provide extra stability and stiffness to the floating offshore wind turbine assembly, which includes, for example, a substructure, such as substructure 100, and a supported device, such as wind turbine 34. Legs 104 are battered and twisted with respect to a main stem axis or centerline 108 and arranged into two pairs.

Within a pair, legs 104 are slightly staggered in their distance from the central stem axis so to accommodate mooring tendons 106 without interference. Such staggering may be, for example, in a range of 3 centimeters to 200 centimeters. This arrangement provides excellent yaw stability for the floating offshore wind turbine assembly. The batter angle for each of legs 104 can be in a range from 5 degrees to about 20 degrees. This range of angles is to accommodate different geometries of turbines 34 and hub-heights and requirements of yaw stiffness. The virtual intersections of the tendon axes above the substructure when viewing tendon axes approximately perpendicular to the axes can be fine-tuned to minimize the motion of turbine nacelle 44. The preload must be optimized (minimized) to reduce costs, by realizing the minimum load that keeps the tendons under tension (no slack) under all turbine-operating and non-operating conditions as well as all the predicted environmental effects (e.g., low-tides, storm conditions). Furthermore, the tendons are sized with a partial safety factor (1.2-2 depending on the level of safety and under load effects on the components), and the minimum preload will guarantee a minimum cross-section and thus cost. Typical preloads range between 5,000-15,000 Kilonewtons per tendon. The angle of twist of the legs (and thus tendons) is optimized as a trade-off between yaw, lateral (sway, pitch, and roll), and heave stiffness, and can vary between 0 degrees (minimum yaw stiffness and max lateral stiffness) to approximately 45 degrees. The trade-off is also on footprint, and larger angles yield larger anchoring footprint at the seabed. A preferred range of angles is about 5 degrees to about 20 degrees. In the context of this disclosure, “about” in an exemplary embodiment is 20% of each angle.

For a typical 15-MW class turbine, the draft of hull or stem 102 can be in a range between 15 meters and 40 meters. The diameter of hull or stem 102 are determined in view of draft, with a larger diameter corresponding to a shallower draft. In an exemplary embodiment, the diameter of hull or stem 102 is in a range from 14 meters to 10 meters, corresponding approximately with drafts of 15 meters and 40 meters, respectively. Leg diameters can be in a range from 6 meters to 12 meters. Wall thicknesses are similar to those of substructure 10, being approximately 1 inch or 26 millimeters, though the range can vary from 0.5 inches (12-13 millimeters) to more than 1 inch (26 millimeters), depending on the application. Here correspondence between English and metric are not exact since available steel sheet when sized in metric dimensions may not be exactly equivalent to the closest standard English measurement. For example, steel sheet may be available at 1 inch, but the closest equivalent from a facility producing sheet steel in metric dimensions may be 25 or 26 millimeters.

The various walls of hull or stem 102, legs 104 and braces may include outfitting as customary in the industry, including stiffeners. The draft is optimized depending on water-depth and installation constraints. As mentioned hereinabove, an advantage of a tension leg platform (TLP) is reduced footprint on the seabed and limited motion of the turbine rotor nacelle assembly (RNA) when compared to other floater archetypes (spar-buoy and semis). The typical TLP requires additional measures during transportation to ensure stability while towed. These measures may include additional ballasting tanks and buoyancy units. The KeyFLOAT can be thought as a hybrid between a spar and a TLP, therefore the draft and ballast and the overall length of the main column can be designed to offer the required stability under towing conditions. Once installed extra-ballast is removed and the necessary preload ensured in tendons 106.

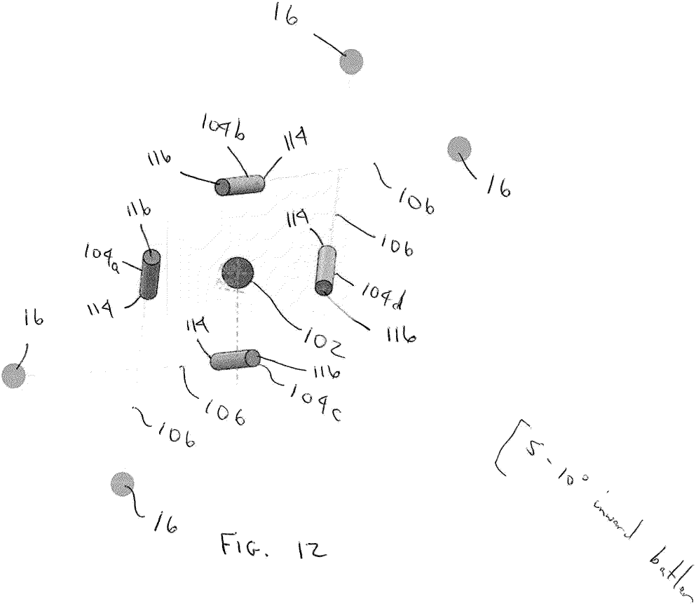

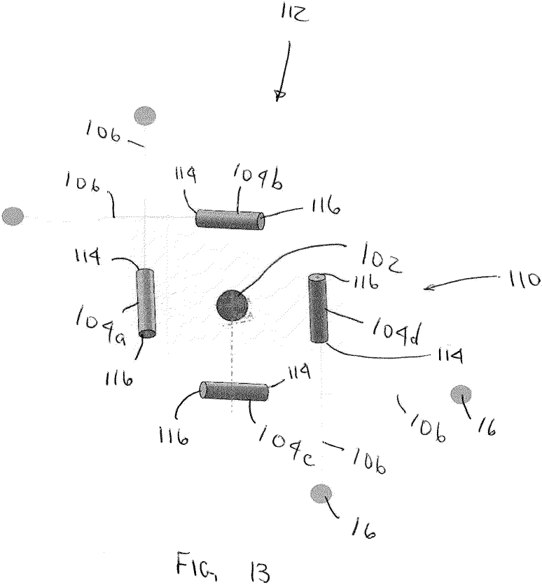

Referring to FIGS. 12 and 13, it should be apparent that legs 104 can be considered as two pairs, each of which are mirrored with each other. More specifically, a first pair 110 includes legs 104 that appear to extend angularly away from each other such that a bottom 114 of each leg 104 within first pair 110 are closer to each other than are tops 116 of each leg 104. In FIG. 12, the angle of legs 104 is approximately 20 degrees from the vertical. In FIG. 13, the angle of legs 104 is approximately 45 degrees from the vertical. In FIG. 12, each leg 104 is inwardly angled at top end 116 at an approximate angle of 5 degrees from a line extending perpendicularly from hull 102 when viewed from above.

As can be seen in FIG. 13, bottom ends 114 of legs 104c and 104d are closer to each other than top ends 116 of legs 104a and 104b. Further, top ends 116 of legs 104a and 104c are closer to each other than top ends 116 of legs 104c and 104d, and similarly top ends 116 of legs 104b and 104d are closer to each other than top ends 116 of legs 104a and 104b. Additionally, top ends 116 of legs 104a and 104c, as well as legs 104b and 104d, are approximately the same distance from each other as bottom ends 114 of legs 104a and 104b, as well as legs 104c and 104d.

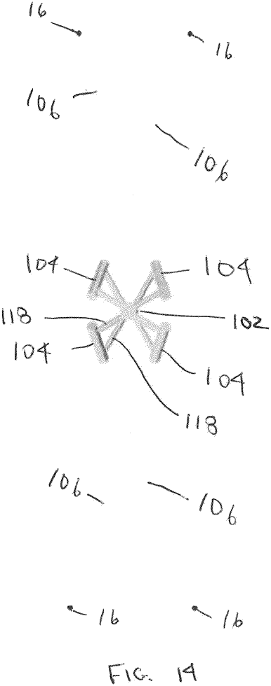

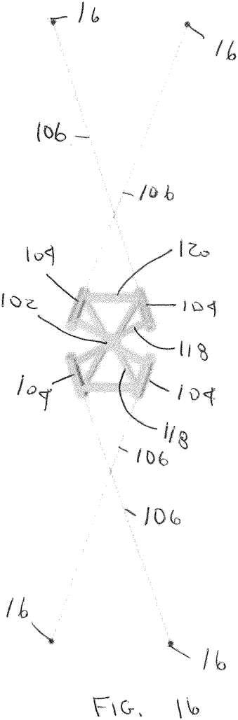

FIGS. 14-16 show braces 118 positioned between legs 104 and hull or stem 102. Legs 104 can be similar to legs 18 of the first embodiment in terms of constructions. FIG. 16 also shows a cross brace 120 extending from a lower end of pairs of legs 104 that are closest to each other of the four legs. Accordingly, there are two cross braces 120 extending directly between bottom ends of a first pair of legs on a first side of central hull or stem 102 and between bottom ends of a second pair of legs on a second, opposite side of central hull or stem 102 from the first side. Mooring lines or tendons 106 extend from each leg 104. When view from above, pairs of mooring lines or tendons 106 cross each other. Each pair of mooring lines or tendons 106 includes a first mooring line 106 and a second mooring lines 106. Thus, each first mooring line 106 extends from a first side of a second mooring line 106 to a second, opposite side of the second mooring, and each second mooring line 106 extends from a first side of first mooring line 106 to a second side of first mooring lines 106. Legs 104 of FIG. 14 are battered or angled approximately 10 degrees away from central hull 102, and are angled or twisted approximately 15 degrees in a circumferential or azimuthal direction.

While various embodiments of the disclosure have been shown and described, it is understood that these embodiments are not limited thereto. The embodiments may be changed, modified, and further applied by those skilled in the art. Therefore, these embodiments are not limited to the detail shown and described previously, but also include all such changes and modifications.

We claim:

1. An offshore substructure comprising:
a central hull;
a plurality of legs positioned around the central hull;
a plurality of braces, each of the plurality of braces being directly connected to the central hull and to one of the plurality of legs;
ballast positioned in at least one of the central hull and the plurality of legs; and
a plurality of moors, each one of the plurality of legs and the central hull being attached to a respective one of the plurality of moors at a first end, and each one of the plurality of moors being attached to an anchor at a second end.

2. The offshore substructure of claim 1, including a winch positioned in the central hull and each of the plurality of legs, the first end of each of the plurality of moors being attached to a respective winch.

3. The offshore substructure of claim 1, wherein the moor is a mooring line.

4. The offshore substructure of claim 1, wherein the moor is a tendon.

5. The offshore substructure of claim 4, wherein the moor is under a preload.

6. The offshore substructure of claim 5, wherein the preload in each is in a range of 5,000 to 15,000 kilonewtons.

7. The offshore substructure of claim 1, wherein the plurality of legs is four legs, and each leg of a pair of legs includes an upper end and a lower end, and the upper ends of each pair of legs are closer to each other than the lower ends.

8. The offshore substructure of claim 7, wherein each leg is at an angle that is in a range of 5 to 20 degrees from a vertical axis.

9. The offshore substructure of claim 1, wherein the central hull includes a diameter in a range of approximately 14 meters to 10 meters and each leg includes a diameter in a range of 6 meters to 10 meters.

10. An offshore substructure comprising:
a central hull;
four legs positioned around the central hull;
a plurality of braces, each of the plurality of braces being directly connected to one of the four legs and to the central hull;
a first pair of moors including a first moor and a second moor, each of the first moor and the second moor connected to a respective leg of a first pair of the four legs, the first moor of the first pair crossing from a first side of the second moor of the first pair to a second side of the second moor of the first pair when viewed from above the central hull; and
a second pair of moors including a first moor and a second moor, each of the first moor and the second moor connected to a respective leg of a second pair of the four legs, the first moor of the second pair crossing from a first side of the second moor of the second pair to a second side of the second moor of the second moor when viewed from above the central hull.

11. The offshore substructure of claim 10, including a winch positioned in each of the four legs, a first end of each of the first pair of moors and each of the second pair of moors being attached to a respective winch.

12. The offshore substructure of claim 10, wherein the moor is a mooring line.

13. The offshore substructure of claim 10, wherein the moor is a tendon.

14. The offshore substructure of claim 13, wherein the moor is under a preload.

15. The offshore substructure of claim 14, wherein the preload in each is in a range of 5,000 to 15,000 kilonewtons.

16. The offshore substructure of claim 10, wherein the four legs include a first pair of legs and a second pair of legs, and each leg of the first pair of legs includes an upper end and a lower end, and the upper ends of the first pair of legs are closer to each other than the lower ends.

17. The offshore substructure of claim 16, wherein each leg is at an angle that is in a range of 5 to 20 degrees from a vertical axis.

18. The offshore substructure of claim 10, wherein the central hull includes a diameter in a range of approximately 14 meters to 10 meters and each leg includes a diameter in a range of 6 meters to 10 meters.
